(19) United States
(12) Patent Application Publication
(10) Pub. No.: US 2010/0083098 A1
(43) Pub. Date: Apr. 1, 2010

(54) Streaming Information that Describes a Webpage

(75) Inventors: Nelson G. M. Leme, Issaquah, WA (US); Govind Varshney, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/241,456

(22) Filed: Sep. 30, 2008

(51) Int. Cl. G06F 17/00; G06F 15/16

(52) U.S. Cl. 715/234; 709/231

(57) ABSTRACT

Techniques to stream information describing a webpage are described. In an implementation, a webpage having a plurality of objects is accessed over a network. As changes are made to the webpage, elements describing changes to objects within the webpage are generated and streamed to an application. In another implementation, a stream of elements from a browser is received. Each of the elements describes a change to an object in a webpage accessed by the browser.

### BACKGROUND

Some applications, such as anti-phishing filter applications, are configured to receive information from a web browser regarding a webpage the browser has loaded. The applications typically obtain this information by calling functions of the browser which cause the browser to return lists of each of the objects that are present in the webpage (e.g., frames, input fields, anchors, images, applets, embedded objects, and so on). The application may also call another function that returns each of the anchors inside a given frame, and so on, until the information that is to be used by the application is received from the browser.

Each time a webpage changes its content, the application in this instance calls each of the aforementioned functions and traverse each of the objects in the webpage again to obtain updated information. Consequently, the use of these traditional function calls to obtain information about a webpage may consume a significant amount of resources (e.g., processing and memory resources), especially if the webpage that is being accessed is dynamic, when multiple applications make function calls to the browser concurrently, and so on.

### SUMMARY

Techniques are described to stream information describing a webpage to an application. In an implementation, a webpage having a plurality of objects is accessed over a network. As changes are made to the webpage, elements describing changes to objects within the webpage are generated and streamed to the application.

In another implementation, a stream of elements from a browser is received. Each of the elements in the stream describes a change to an object in a webpage accessed by the browser.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to stream information describing a webpage to one or more applications.

FIG. 2 is an illustration of a system in an example implementation showing the computing device of FIG. 1 in greater detail.

FIG. 3 is an illustration depicting an element in a stream of elements of an example implementation.

FIG. 4 is an illustration depicting the addition of an element to a stream of elements as changes are made to a webpage in an example implementation.

FIG. 5 is a flow diagram depicting a procedure in an example implementation in which information describing a webpage is streamed to an application.

FIG. 6 is a flow diagram depicting a procedure in an example implementation in which a stream of elements from a browser is received.

### DETAILED DESCRIPTION

Overview

Dynamic webpages are becoming increasingly commonplace. Such webpages tend to contain large amounts of content which may change frequently. For example, a news page may display content such as text, images, embedded video, graphics, audio, pop-up advertisements, and so on, separated by frames within the page. Because of the dynamic nature of the information presented, the news page may refresh itself often, allowing new content to replace older content, existing content to be rearranged or reformatted within the page, new sponsoring advertisements to be displayed, and so forth. However, typically just a portion of the content within a dynamic webpage is normally changed at any given time. Indeed, it is a rare occurrence when a webpage change each content item at once that is included in the webpage. Consequently when used with dynamic webpages, traditional techniques that traverse each of the objects within a webpage each time the webpage changes may be inefficient.

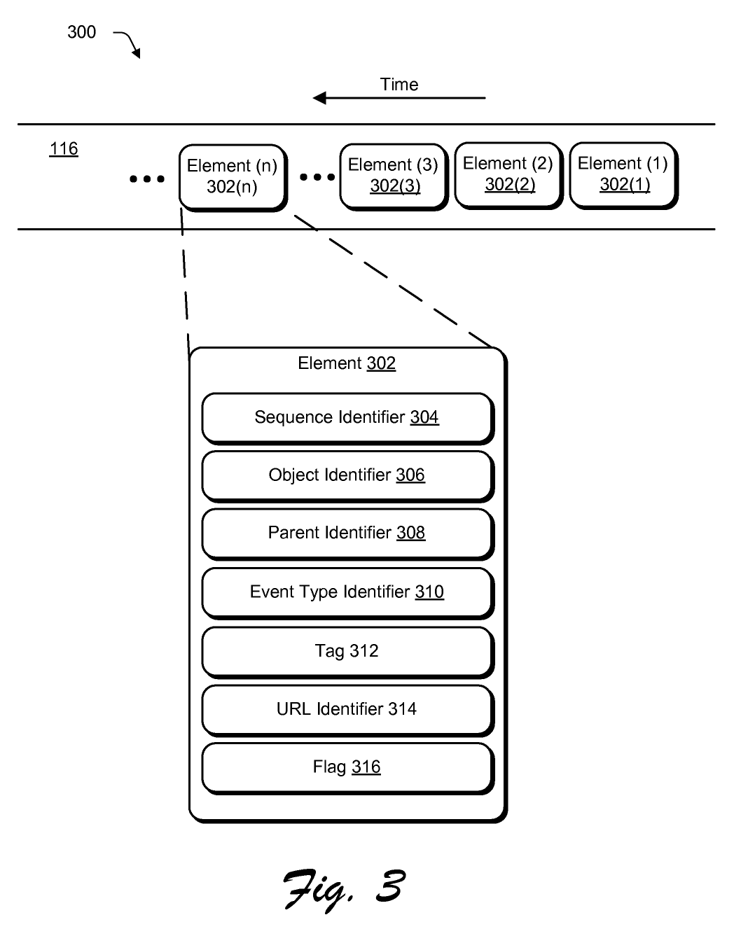

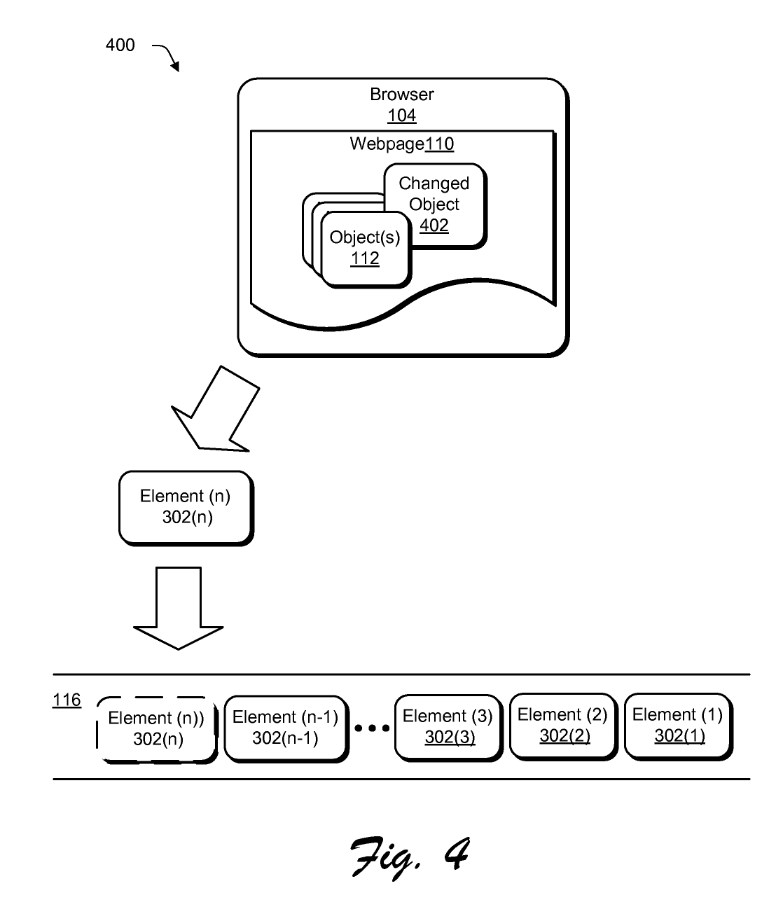

Techniques are described to stream information describing changes to a webpage to one or more applications. The techniques described thus allow information to be shared with other applications with increased efficiently by eliminating queries to the browser for the information. In an implementation, a webpage having a plurality of objects (e.g., frames, input fields, anchors, images, applets, embedded objects, and so on) is accessed by a browser over a network. As changes are made to the webpage, elements describing changes to objects in the webpage are generated and streamed to the applications to provide information about the webpage to the applications. The elements streamed may be immutable, read-only records that contain information describing changes to objects in the webpage. Each element within a stream of elements may contain sufficient data to give all the information needed to fully describe a change to a given object in the webpage. Further discussion of element content and generation may be found in relation to FIGS. 3 and 4.

In another implementation, the receipt of a stream of elements from a browser by an application is described. As noted above, each of the elements in the steam of elements received describes a change to an object in a webpage accessed by the browser. Such changes may include the addition of an object to the webpage, the deletion of an object from the webpage, or the modification of an object within the web page. In this way, when a change is made to a webpage, applications receiving the stream of elements are provided with information describing the changes to objects within the webpage which result from changes to the webpage. The applications may use this information to update information previously received via the stream of elements in order to fully describe the webpage.

In the following discussion, an exemplary environment is first described that is operable to perform the techniques for streaming information about a webpage described herein. Exemplary procedures are then described which may be employed in the exemplary environment, as well as in other environments without departing from the spirit and scope thereof.

Example Environment

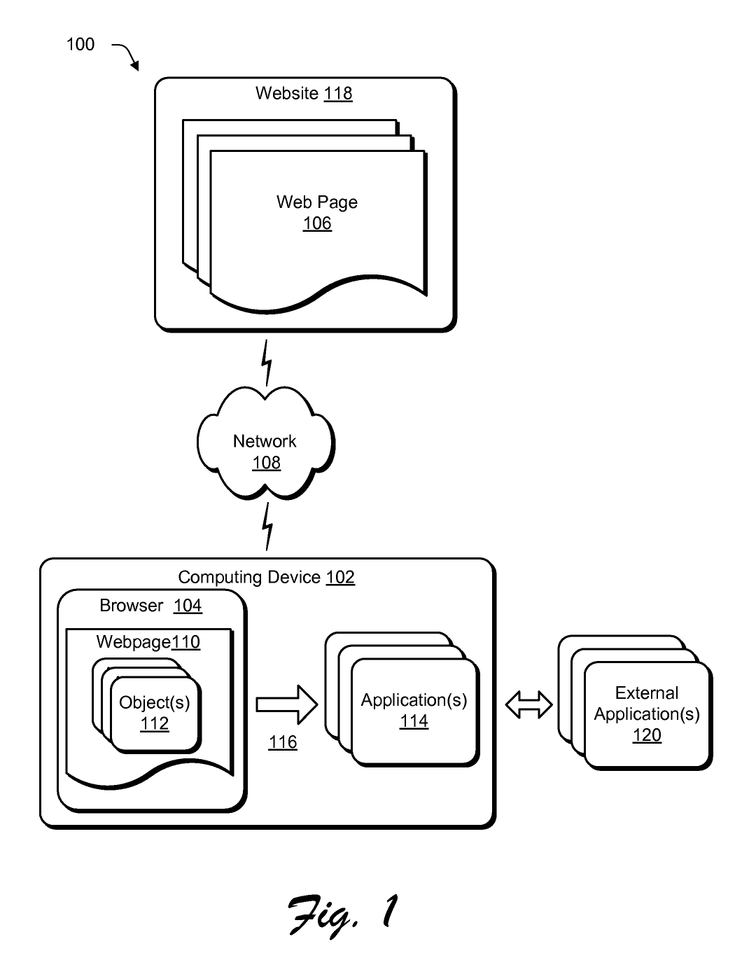

FIG. 1 is an illustration of an environment 100 in an example implementation that is operable to employ techniques to generate a stream of elements describing changes to a webpage. The illustrated embodiment 100 includes a computing device 102 having a browser 104 that is operable to access a webpage 106 over a network 108.

The computing device 102 may be configured in a variety of ways. For example, the computing device 102 may be configured as a computer such as a desktop or laptop computer that is capable of communicating over a wired or wireless network. The computing device 102 may also be configured as a mobile connected device such as a personal digital assistant, a smart phone, or a cell phone that is capable of communicating over a wireless network; an entertainment appliance; a set-top box communicatively coupled to a display device; a game console, and so forth. Thus, the computing device 102 may range from a full resource device with substantial memory and processor resources (e.g., a personal computer, a game console, etc.) to a low-resource device with limited memory and/or processing resources (e.g., a cell phone, a set top box, etc.).

The browser 104 enables the computing device 102 to display and interact with a webpage 106 such as a webpage within the World Wide Web, a webpage provided by a web server in a private network, and so forth. The browser 104 may be configured in a variety of ways. For example, the browser 104 may be configured as a web browser suitable for use by a full resource device with substantial memory and processor resources (e.g., a personal computer, a laptop computer, a game console, etc.). In other implementations, the browser may be configured as a mobile browser suitable for use by a low-resource device with limited memory and/or processing resources (e.g., a PDA, a smart phone, a cell phone, etc.). Such mobile browsers typically conserve memory and processor resources, but may offer fewer browser functions than web browsers.

The network 108 may assume a wide variety of configurations. For example, the network 108 may include the Internet, a wide area network (WAN), a local area network (LAN), a wireless network (e.g., a WIFI (IEEE 802.11) network), a cellular telephone network, a public telephone network, an extranet, an intranet, and so on. Further, although a single network 108 is shown, the network 108 may be configured to include multiple networks. For instance, a desktop or laptop computer may connect to the Internet via a local area network so that the computer's web browser may access a webpage provided by a website within the World Wide Web (WWW). Similarly, a mobile browser in a smart phone may access a webpage within a corporate intranet via a cellular telephone network. A wide variety of other instances are contemplated.

As illustrated in FIG. 1, a webpage 106 is accessed by the computing device 102. For example, the accessed webpage 106 may be loaded into the browser 104 of the computing device 102. The loaded webpage 110 may include a plurality of objects 112. Generally, objects 112 may include any content element used in the construction and display of a webpage 110. In specific implementations, example objects 112 may include Hypertext Markup Language (HTML) elements such as frames, input fields, anchors, images, applets, embedded objects, and so on.

As changes are made to the loaded webpage 110, elements describing changes to objects 112 within the webpage 110 are generated and streamed to one or more applications 114 to provide information about the webpage to the application(s) 114. The changes to the objects 110 described may include the addition of an object 112 to the webpage 110, the deletion of an object 112 from the webpage 110, or the modification of an object 112 within the webpage 110.

The applications 114 which receive the stream of elements 116 may include a variety of different types of application that utilize information about a webpage 110 accessed by the browser 104. In example implementations, the applications 114 may use the information in the stream of elements 116 to perform an operation with respect to the webpage 110. Example applications 114 operable to receive the stream of elements 116 may include computer programs which receive information from the browser, plug-in modules suitable for addition to the browser 104, and so forth. In a specific implementation, an example application 114 may be an anti-phishing filter application that may use information provided in the stream of elements 116 for monitoring a website 118 that provided the webpage 106 for phishing attacks.

In specific implementations, one or more of the applications 114 may interface with other applications to share information received in the stream of elements 116, to provide an operation to a second application using information received in the stream of elements 116, and so forth. For instance, an application 114 may interface with one or more applications 120 that are external to the computing device 102, e.g., via the network 108, via a separate second network, via a connection with a second computing device on which an external application 120 resides, and so on. Additionally, the stream of elements 116 generated by the browser 104 may be sent to one or more external applications 120. In such instances, an application 114 within the computing device 102 may act as a gateway for passing of the stream of elements 116 to the external application 120.

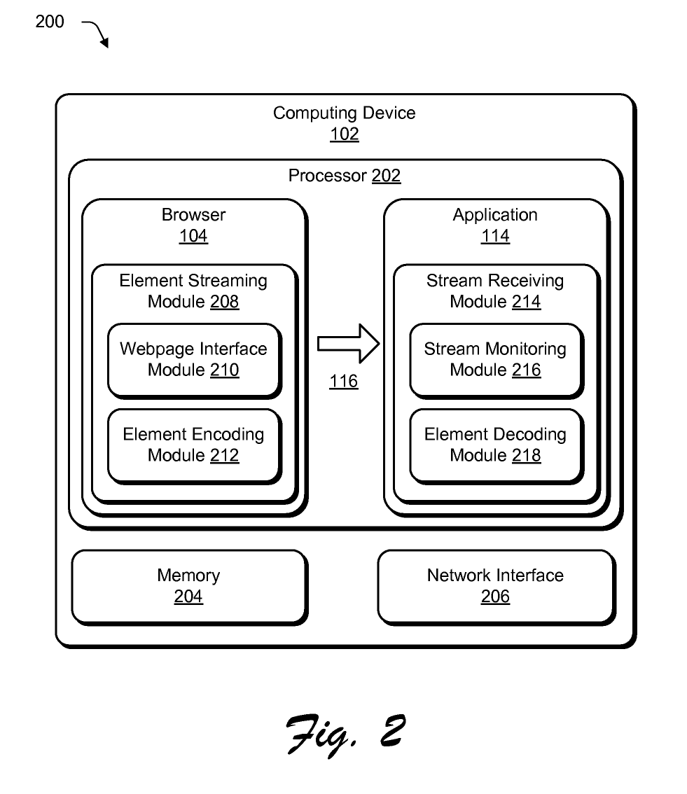

FIG. 2 illustrates a system 200 in an example implementation showing the computing device 102 of FIG. 1 in greater detail. The computing device 102 may include a processor 202, memory 204 and a network interface 206.

The processor 202 provides processing functionality for the computing device 102 and may include any number of processors, micro-controllers, or other processing systems and resident or external memory for storing data and other information accessed or generated by the computing device 102. The processor 202 may execute one or more software programs which implement techniques described herein. The processor 202 is not limited by the materials from which it is formed or the processing mechanisms employed therein, and as such, may be implemented via semiconductor(s) and/or transistors (e.g., electronic integrated circuits (ICs)), and so forth.

The memory 204 is an example of computer-readable media that provides storage functionality for storing various data associated with the operation of the computing device 102, such as the software program and code segments mentioned above, or other data for instructing the processor 202 and other device elements to perform the steps described herein. Although a single memory 204 is shown, a wide variety of types and combinations of memory may be employed. The memory 204 may be integral with the processor 202, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth. In embodiments, the memory 204 may include removable ICC (Integrated Circuit Card) memory such as provided by SIM (Subscriber Identity Module) cards, USIM (Universal Subscriber Identity Module) cards, UICC (Universal Integrated Circuit Cards), and so on.

The network interface 206 provides functionality for enabling the computing device 102 to communicate with one or more networks, such as network 108 of FIG. 1. In various implementations, the network interface 206 may include a variety of components such as modems, routers, wireless access points, cellular telephone transceivers, and so forth, and any associated software employed by these components (e.g., drivers, configuration software, etc.). In FIG. 2, the network interface 206 is illustrated as being an internal component of the computing device 102. However, in some implementations, one or more components of the network interface 206 may be external components coupled to the computing device 102 via a wired or wireless connection.

The browser 104, which may be implemented as a software application executed by the processor 202, may include an element streaming module 208 which represents functionality for streaming information describing a webpage loaded by the browser 104 to an application, such as application 114. As changes are made to the webpage loaded in the browser 104, the element streaming module 208 may generate elements describing changes to objects within the webpage and streams them to the application 114. In FIG. 2, the element streaming module 208 is illustrated as an integral part of the browser 104. However, it should be readily apparent that the element streaming module 208 may also be implemented as a third party plug-in module that may be added to the browser 104, a separate software program, and so forth.

In the implementation illustrated in FIG. 2, the element streaming module 208 includes a webpage interface module 210 and an element encoding module 212. The webpage interface module 210 represents functionality to detect changes to a webpage loaded by the browser 104. For example, the webpage interface module 210 may receive information from the webpage indicating that an object within the webpage has changed.

An object within the webpage may be changed in a variety of ways. In a first example, an object may be added to the webpage. For instance, a webmail page may add a new email listing indicating that an email has been received. To display the new email listing, one or more objects (e.g., additional frames, text, images, etc.) may be added to the webpage. Second, an existing object may be deleted from the webpage. For instance, a news page may delete an image after a period of time causing the deletion of one or more objects used for display of the image from the webpage. Third, an existing object within the webpage may be modified. For instance, the background color of textual material within a frame of a webpage may change color causing one or more objects within the webpage to be modified.

The element encoding module 212 represents functionality for generating elements describing changes to the objects within the webpage. The element encoding module 212 may receive information about changes to objects within the webpage from the webpage interface module 210. This information may be used to format elements which describe the changes. The element streaming module 204 may then send the element to the application 114 in the stream of elements 116. As discussed later in relation to FIG. 4, the elements may be immutable, read-only records describing a specific change to a specific object in the webpage. Thus in this example, once generated and inserted into the stream of elements 116, an element cannot be altered thereafter. Other examples are also contemplated as previously described.

The application 114 may be implemented in a variety of ways, such as a software application executed by the processor 202 of the computing device 102 as illustrated in FIG. 2. The application 114 may include a stream receiving module 214 that represents functionality for receiving the stream of elements 116 from the browser 104 and extracting information describing changes to the webpage from the elements within the stream.

In the implementation illustrated in FIG. 2, the stream receiving module 214 includes a stream monitoring module 216 and an element decoding module 218. The stream monitoring module 216 represents functionality for receiving the stream of elements 116 from the browser 104. For example, as discussed above, when a webpage is loaded by the browser 104, the browser 104 may automatically generate and stream elements describing objects in the webpage that are changed (e.g., added, deleted, or modified). The streaming of elements may begin when the webpage is initially loaded and thereafter continue as necessary to send additional elements describing changes to objects in the webpage. The stream monitoring module 216 may detect that elements describing a webpage are being streamed from the browser 104 and then “listen” to the stream of elements 116 to receive those elements.

The element decoding module 218 represents functionality for extracting information from the stream of elements 116 received by the stream monitoring module 216. The application 114 may store the information extracted from the stream of elements 116 to recreate a snapshot of the webpage at a point in time before the webpage was loaded in the browser 104. However, it is contemplated that, in at least some implementations, the actual elements streamed from the browser 104 to the application 114 are not retained.

FIG. 3 is an illustration depicting an element 302 in a stream of elements 116 of an example implementation. As discussed in relation to FIGS. 1 and 2, information 300 describing a webpage may be formatted as a stream of elements 116 passed from a browser 104 to one or more applications 114. In implementation illustrated in FIG. 3, the streamed elements 302 are delivered and received sequentially in real time or near real time as changes are made to the webpage. Thus, in the stream of elements 116 shown, a first element 302(1) describing a first change to an object in the webpage is sent first in the stream of elements 116. The first element 302(1) is followed sequentially in the stream of elements 116 by a second element 302(2) describing a second change to an object in the webpage. The second element 302(2) is in turn followed by a third element 302(3) describing a third change to an object in the webpage, and so forth. In example embodiments, up to “n” elements (e.g., element 302(n)) may be streamed, where n is an integer greater than zero (n>0) representing the number of elements 302 needed to effectively describe all changes to all objects within the webpage.

As mentioned above, the elements 302 may be immutable read-only records that contain information describing changes to objects in the webpage. Each element 302 may contain sufficient data to give information that fully describes a change to a given object. As discussed, changes to objects in the webpage may include the addition of a new object to the webpage, the deletion of an already existing object from the webpage, or the modification of an already existing object in the webpage. Thus, for example, an initial element (e.g., element 302(1)) may describe the addition of an object to the webpage. Subsequent elements (e.g., element 302(3)) may then address already existing objects to keep information about these objects timely by describing the modification or deletion of the objects. In this manner, the stream of elements 116 may describe each of the objects within the webpage even if those objects may change over time. An application (e.g., application 114 of FIG. 2) may track changes to objects 112 in the webpage 110 described by the stream of elements 116 to obtain a complete description of the webpage 110 at any given time.

Each element 302 may be configured with a variety of data. In various implementations, each element 302 may include one or more fields containing specific data items. For example, as illustrated in FIG. 3, the elements 302 may be formatted with fields including a sequence identifier 304, an object identifier 306, a parent identifier 308, an event type identifier 310, a tag 312, a URL identifier 314, a flag 316, and so forth.

The sequence identifier 304 identifies the element 302 in the stream of elements 116. The sequence identifier 304 is unique for each element 302 and may be indexed for each successive element 302 in the stream of elements 116 (e.g., the sequence identifier 304 may increase for each successive element 302 sent by the browser). In this way, an application (such as application 114 of FIG. 2) may monitor the stream of elements 116 and determine which elements 302 have already been processed (e.g., have already been received by the application and had information extracted from them). Thus, even if the elements 302 are received out of order, the exact sequence in which the elements were to have been received may be reconstructed.

The object identifier 306 identifies the object in the webpage described by the element 302. The object identifier 306 is unique to each object in the webpage (e.g., each frame, each input field, each anchor, each image, and so on). Data contained in the element 302 describes the object identified by the object identifier 306.

The parent identifier 308 identifies a parent object to the object identified by the object identifier 306. More specifically, the parent identifier 308 may identify the object that contains the object identified by the object identifier 306. For example, the element 302 may describe an anchor contained inside of a frame within the webpage. The object identifier 306 uniquely identifies the anchor, while the parent identifier 308 identifies the frame containing the anchor. In specific implementations, the object identifier 306 and the parent identifier 308 may contain data that is identical in structure. Thus, data contained in the object identifier 306 of a first element 302 (e.g., an element describing the frame) may be identical to the data contained in the parent identifier 308 of one or more additional elements 302 (e.g., an element describing the anchor).

The event type identifier 310 describes the change made to the object identified by the object identifier 306. More specifically, the event type identifier 310 identifies whether the object described by the element 302 is added to the webpage (e.g., the event type identifier 310 may be “add”), deleted from the webpage (e.g., the event type identifier 310 may be “delete”), or modified within the webpage (e.g., the event type identifier 310 may be “modify”). For instance, in the example discussed above, the URL to which the anchor points may be changed. The element 302 describing the anchor may have an event type identifier 310 which identifies the change to the object as “modify” to indicate that the anchor has been modified.

The tag 312 specifies an object type for the object described by the element 302 and identified by the object identifier 306. Thus, the tag 312 specifies the kind of object the element 302 describes (e.g., a frame, an input field, an anchor, an image, etc.).

The URL identifier 314 may contain a Uniform Resource Locator (URL) that refers to the object identified by the object identifier 306. The URL may specify the location in the network where the identified object is available and the protocol for its retrieval. The URL identifier 314 may also transfer string information such as text (e.g., the title of the webpage), and so forth.

The flag 316 may contain information about the object described by the element 302. For example, the flag 316 may store flag data that provides additional information about a given type of object in the webpage. The information provided may vary depending on the specific type of object being described.

It is contemplated that elements 302 may be formatted in a variety of ways. For example, elements 302 may be formatted to include some but not all fields illustrated in the example implementation of FIG. 3. Thus, in one specific implementation, an element 302 might include only a sequence identifier 304, an object identifier 306, a parent identifier 308, and an event type identifier 310, or a similar combination of fields. Additionally, it is contemplated that elements 302 may be formatted to include other fields instead of or in addition to the fields specifically discussed herein.

FIG. 4 is an illustration depicting an operation 400 for generating and streaming an element 302(n) as changes are made to a webpage 110 in an example implementation. When a webpage 110 is initially loaded by the browser 104, one or more objects 112 may be added to the webpage 110 as the webpage 110 loads. Accordingly, elements 302 describing the objects 112 being loaded may be generated and added to the stream of elements 116 as the objects 112 are added to the webpage 110. For example, in a specific implementation, the first element 302(1) in the stream of elements 116 may describe the top level page (which may be classified as a frame). This element 302(1) may contain the URL of the top level page (e.g., contained within the URL identifier 314 of the element 302(1) as described in relation to FIG. 3). Each other element (e.g., element 302(2), element 302(3) through element 302(n)) may refer back to the first element 302(1) through n levels of indirection where n is an integer greater than zero (n>0). For example, the elements 302(1), 302(2) through 302(n) may indirectly refer back to the first element 302(1) by following the parent identifiers 308 of preceding elements 302 in the stream of elements 116 as discussed in relation to FIG. 3.

In one or more instances, the first elements 302 in the stream of elements 116 describe addition of objects 112 to the webpage 110 as the webpage 110 is loaded. Thus, these initial elements 302 may identify the change to the object 112 as the addition of the object 112 to the webpage 110, which initially was empty. For example, in the implementation illustrated in FIG. 3, the event type identifiers 310 may be “add” for initial elements 302 in the stream of elements 116. In some instances, one or more objects 112 initially added as the webpage 110 is loaded may thereafter be modified or deleted before the webpage 110 is fully loaded. For example, during loading of a webpage 110, a user input field may be temporarily displayed to request user input and then removed when the input is received. In such instances, one or more elements 302 may be generated to describe the modification or deletion of the object(s) 112. As discussed in relation to FIG. 3, the event type identifiers 310 for these elements 302 may be “modify” or “delete.”

Later, after the webpage 110 is loaded, additional elements 302(n) may be sent to describe changes to the webpage (e.g., because of scripts, user interaction, etc.). For example, as shown in FIG. 4, as an object 402 may be changed (e.g., added, modified or deleted) in the webpage 110. An additional element (“Element (n)”) 302(n) may be generated and added to the stream of elements 116 to describe the change to the object 402. The added element 302(n) is sent sequentially following the last element (e.g. “Element (n-1)” 302(n-1)) sent in the stream at the point in time the object 402 was changed. The additional element 302(n) may describe the change to the object 402. The event type identifier 310 for the element 302(n) may be “add,” “modify,” or “delete” depending on the change made to the object 402, as discussed in relation to FIG. 3.

Generally, any of the functions described herein can be implemented using software, firmware, hardware (e.g., fixed logic circuitry), manual processing, or a combination of these implementations. The terms “module” and “functionality” as used herein generally represent software, firmware, hardware or a combination thereof. In the case of a software implementation, for instance, the module represents executable instructions that perform specified tasks when executed on a processor, such as the processor 202 of the computing device 102 of FIG. 2. The program code can be stored in one or more computer readable media, an example of which is the memory 204 of the computing device 102 of FIG. 2. The features of the techniques to stream information describing a webpage described below are platform-independent, meaning that the techniques may be implemented on a variety of commercial computing platforms having a variety of processors.

Example Procedures

The following discussion describes techniques for streaming information describing a webpage that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2, the information 300 of FIG. 3, and the operation 400 of FIG. 4.

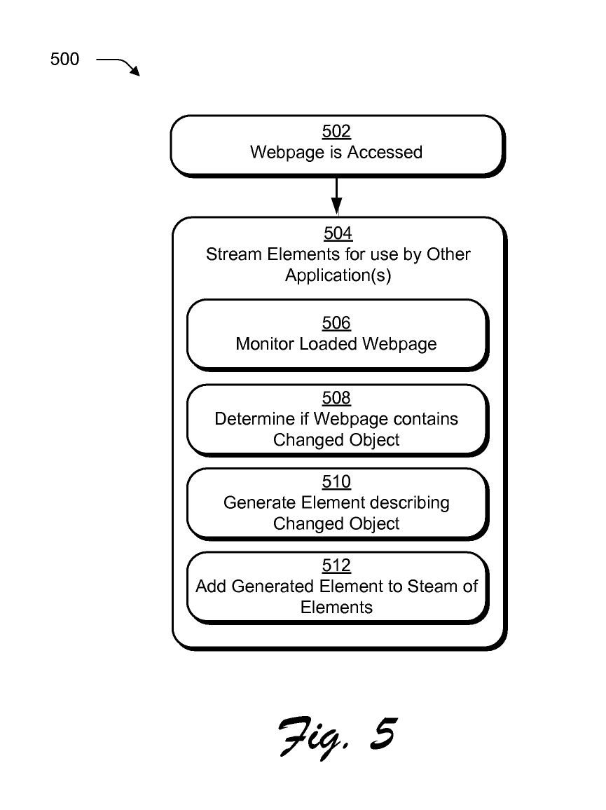

FIG. 5 is a flow diagram 500 depicting a procedure in an example implementation in which information describing a webpage is streamed to an application. A webpage is first accessed over a network (block 502). For example, a webpage 106 may be loaded into the browser 110 of the computing device 102 as described in relation to FIGS. 1 and 2. As changes are made to the webpage, elements describing changes to objects within the webpage are generated and sent to one or more applications as a stream of elements (block 504). The elements may be formatted to provide specific information about the objects to the applications. Example element formats are described in the discussion of FIG. 3.

In the implementation illustrated in FIG. 5, the accessed webpage may be monitored (block 506) to detect changes to objects within the webpage. For example, the webpage may provide information indicating that an object within the webpage has been changed. However, the browser may also detect changes to the webpage. When it is determined that an object within the webpage has changed (block 508), an element describing the change to the webpage is generated (block 510) and added to a stream of elements (block 512) sent to the application.

An element may be generated each time an object within the webpage is changed (e.g., added, modified or deleted). For example, as a webpage is initially accessed and loaded by the browser, objects may be primarily added to the webpage. Accordingly, elements may be generated and streamed which describe objects that are added to the webpage. Streaming of elements describing the initially loaded objects may continue until the webpage is fully loaded. However, if during this time, one or more objects initially added is thereafter modified or deleted before the webpage is fully loaded, one or more elements may be generated to describe the modification ore deletion of the object(s).

After the webpage is loaded, changes may be made to objects in the webpage. To account for these changes, additional elements may be generated which describe the changes as they occur. These added elements are streamed for use by the application(s).

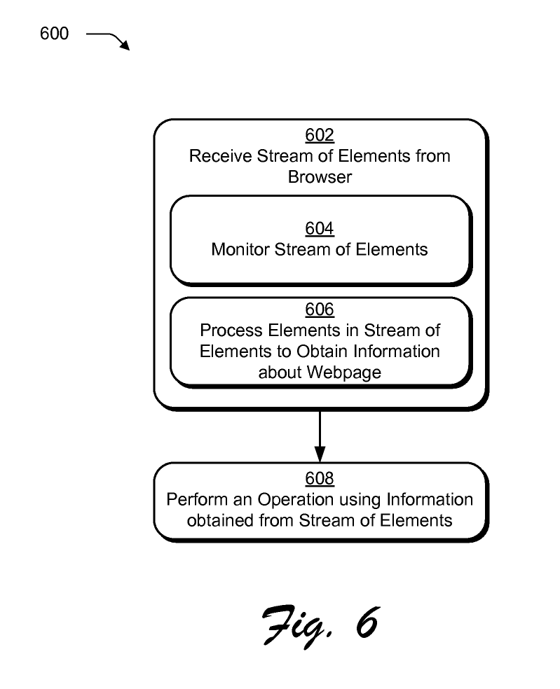

FIG. 6 is a flow diagram 600 depicting a procedure in which a stream of elements from a browser is received in an example implementation. As discussed in relation to FIG. 5, a browser may automatically generate and stream elements describing objects in the webpage that are changed (e.g., added, deleted, or modified) as the webpage is initially loaded. The browser may thereafter stream additional elements as changes to the webpage result in changes to objects in the webpage. This stream of elements is received from the browser (block 602) by the application. Thus, the application may first be provided with information describing objects within the webpage as loaded, followed periodically by information describing changes to objects within the webpage which result from changes to the webpage.

As shown in FIG. 6, when the steam of elements is received (block 602), the stream is monitored to receive the elements within the stream (block 604). Elements within the stream may then be processed as they are received to obtain information about the webpage (block 606). For example, information describing changes to the webpage may be extracted from the elements by an application, which may store the information to allow the recreation of a snapshot of the webpage at any given time that the webpage was accessed by the browser. The information obtained may then be used by the application to perform an operation (block 608). Example operations which may be performed may include monitoring the webpage, monitoring a user's access to the webpage, monitoring the website that provided the webpage for phishing attacks, doing nothing, and so forth.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
generating one or more elements, each of the one or more elements describing a change to an object included in a webpage; and
streaming the one or more elements to an application.

2. A method as described in claim 1, wherein the generating and the streaming are performed through execution of a browser that accessed the webpage.

3. A method as described in claim 1, wherein the webpage is dynamic.

4. A method as described in claim 3, wherein at least one of the elements describes one of: addition of the object to the webpage, deletion of the object from the webpage, and modification of the object in the webpage.

5. A method as described in claim 4, wherein one or more additional elements are added to the stream of elements when a respective said object is added to the webpage, deleted from the webpage, or modified within the webpage.

6. A method as described in claim 1, wherein one or more of the elements are immutable.

7. A method as described in claim 1, wherein each of the one or more elements includes:
a sequence identifier for identifying a respective said element in the stream of elements;
an object identifier for identifying the respective said object described by the element; and
an event type identifier for identifying whether the respective said object is added to the webpage, deleted from the webpage, or modified within the webpage.

8. A method as described in claim 7, wherein each of the elements further includes at least one or more of:
a parent identifier for identifying a parent object to the object identified by the object identifier;
a tag for identifying an object type for the object described by the element;
a URL identifier for containing a URL that that refers to the object described by the element, and
a flag for storing information about the object described by the element.

9. A method as described in claim 1, wherein the application is an anti-phishing filter application and the information is used for monitoring a website that provided the webpage for phishing attacks.

10. One or more computer-readable media comprising instructions that are executable to receive a stream of elements from a browser, each of the elements describing a change to an object in a webpage accessed by the browser.

11. The one or more computer-readable media as described in claim 10, wherein the webpage is dynamic.

12. The one or more computer-readable media as described in claim 11, wherein at least one of the elements describes one of: addition of the object to the webpage, deletion of the object from the webpage, and modification of the object in the webpage.

13. The one or more computer-readable media as described in claim 12, wherein one or more additional elements are added to the stream of elements when a respective said object is added to the webpage, deleted from the webpage, or modified within the webpage.

14. The one or more computer-readable media as described in claim 10, wherein one or more of the elements are read-only.

15. The one or more computer-readable media as described in claim 10, wherein each of the one or more elements includes:
a sequence identifier for identifying a respective said element in the stream of elements;
an object identifier for identifying the respective said object described by the element; and
an event type identifier for identifying whether the respective said object is added to the webpage, deleted from the webpage, or modified within the webpage.

16. The one or more computer-readable media as described in claim 15, wherein each of the elements further includes at least one or more of:
a parent identifier for identifying a parent object to the object identified by the object identifier;
a tag for identifying an object type for the object described by the element;
a URL identifier for containing a URL that that refers to the object described by the element, and
a flag for storing information about the object described by the element.

17. One or more computer-readable media comprising instructions that are executable to provide a browser that is configured to:
access a webpage over a network, the webpage having a plurality of objects; and
stream elements to an application as changes are made to the webpage, each said element describing a change to a respective said object.

18. The one or more computer-readable media as described in claim 17, wherein the elements are read-only.

19. The one or more computer-readable media as described in claim 17, wherein each of the one or more elements includes:
a sequence identifier for identifying a respective said element in the stream of elements;
an object identifier for identifying the respective said object described by the element; and
an event type identifier for identifying whether the respective said object is added to the webpage, deleted from the webpage, or modified within the webpage.

20. The one or more computer-readable media as described in claim 19, wherein each of the elements further includes at least one or more of:
a parent identifier for identifying a parent object to the object identified by the object identifier;
a tag for identifying an object type for the object described by the element;
a URL identifier for containing a URL that that refers to the object described by the element, and
a flag for storing information about the object described by the element.
